(19) United States
(12) Patent Application Publication
(10) Pub. No.: US 2011/0204230 A1
(43) Pub. Date: Aug. 25, 2011

(54) ELECTRON BEAM TYPE SUBSTRATE INSPECTING APPARATUS

(76) Inventor: Daiji Fujiwara, Hitachinaka (JP)

(21) Appl. No.: 13/128,188

(22) PCT Filed: Oct. 29, 2009
(86) PCT No.: PCT/JP2009/068585

§ 371 Date: May 6, 2011

(30) Foreign Application Priority Data
Nov. 6, 2008 (JP) 2008-285672

(51) Int. Cl. G01N 23/225

(52) U.S. Cl. 250/311

(57) ABSTRACT

An electron beam type substrate inspection apparatus (1) capable of inspecting an inspection substrate (8) in a short time is provided.

It includes means (11)(12) for scanning an electron beam (9) within an inspection region on the inspection substrate (8), means (7) for detecting a signal generated from the inspection substrate (8); means (13) for visualizing with a scanning position on the inspection substrate (8) and the signal being related with each other, means (15a) for generating on a layout at least one of a die region indicating a region where a plurality of semiconductor apparatuses are present, a logical circuit region indicating a region where logical circuits are present, a memory circuit region where the memory circuits are present, and a peripheral circuit region indicating a region where peripheral circuits are present, and means (15b) for setting the inspection region with the generated regions.

### TECHNICAL FIELD

The present invention relates to an electron beam type substrate inspecting apparatus for inspecting a substrate to be inspected such as a semiconductor wafer and a liquid crystal substrate.

### BACKGROUND ART

An electron beam type substrate inspecting apparatus can perform inspection for detecting a defect such as an extremely small material on a fine circuit pattern and is highly utilized for improvement in yield of semiconductor apparatuses and displays (see Patent Document 1, etc.) because an electron beam image with a high resolution can be obtained.

### PRIOR ART

[Patent Document 1]

JP 2002-515650A

### DISCLOSURE OF THE INVENTION

1. Summary of the Invention

2. Problem to be Solved by Invention

On a substrate to be inspected, such as a semiconductor wafer and a liquid crystal substrate, extremely fine circuit patterns are formed. As the circuit patterns become finely divided, a defect which may cause an erroneous operation in the semiconductor apparatus and a display, etc. becomes finer. This necessitates inspection for detecting extremely small defects at high magnification conditions, which makes the inspection time period longer.

A problem of the present invention is to provide an electron beam substrate inspecting apparatus capable of inspecting an inspection substrate in a short time period.

### Measure to Solve Problems

The invention which solved the problem is characterized by an electron beam type substrate inspection apparatus comprising:

means for generating, on a layout, at least one of: die regions each indicating a die region where a plurality of semiconductor apparatuses are located on the inspection substrate; a logic region indicating a region where a logic circuit is located in the semiconductor apparatus; a memory circuit region indicating a region where a memory circuit is located in the semiconductor apparatus; and a peripheral circuit region indicating a region where a peripheral circuit is located in the semiconductor apparatus as a region, on the basis of arrangement data of a plurality of semiconductor apparatuses formed on a surface of the inspection substrate and design data of the semiconductor apparatuses; and

means for setting the inspection region using the generated region.

### ADVANTAGEOUS EFFECT OF THE PRESENT INVENTION

The present invention provides the electron beam type substrate apparatus which can inspect the inspection substrate in a short time period.

### BRIEF DESCRIPTION OF DRAWINGS

FIG. 1 is a block diagram of an electron beam type wafer (substrate) inspection apparatus according to embodiments of the present invention;

FIG. 2 is a flowchart of preparing an inspection recipe carried out in the electron beam type wafer (substrate) inspection apparatus according to the embodiments of the present invention;

FIG. 3A is a layout view of semiconductor apparatuses on a wafer (inspection substrate);

FIG. 3B is a layout view of a logic circuit, a memory circuit, and a peripheral circuit on the semiconductor apparatus;

FIG. 4 is a display screen image (a first part) displayed on the electron beam type wafer (substrate) inspection apparatus according to the embodiments of the present invention, and illustrates a status of setting an inspection region in a manual mode;

FIG. 5 is a display screen image (a second part) displayed on the electron beam type wafer (substrate) inspection apparatus according to the embodiments of the present invention, and illustrates a status of setting the inspection region in an automatic mode using past inspection results;

FIG. 6A is a drawing illustrating a positional relation among a memory circuit region, a scan region (electron beam irradiation region), and a scanning path of the electron beam;

FIG. 6B is a drawing illustrating a positional relation among a logic circuit region, the scan region (electron beam irradiation region), and the scanning path of the electron beam;

FIG. 6C is a drawing illustrating a positional relation among a peripheral circuit region, the scan region (electron beam irradiation region), and the scanning pass of the electron beam.

FIG. 7 is a display screen image (a third part) displayed on the electron beam type wafer (substrate) inspection apparatus according to the embodiments of the present invention, and illustrates a status of setting the inspection region in an automatic mode using an inspection result of trial inspection;

FIG. 8A is a display screen image (a fourth part) displayed on the electron beam type wafer (substrate) inspection apparatus according to the embodiments of the present invention, and illustrates a case that a matching ratio between previous inspection results and the trial inspection result is low; and

FIG. 8B is a display screen image (a fifth part) displayed on the electron beam type wafer (substrate) inspection apparatus according to the embodiments of the present invention, and illustrates a case that a matching ratio between previous inspection results and the trial inspection result is increased by adjusting the trial inspection result by increasing and decreasing an obtaining lower limit threshold.

### BEST MODE FOR CARRYING OUT THE INVENTION

Next, with reference to drawings will be described embodiments of the present invention in detail. In each of the drawings, common parts among respective drawings are designated with the same reference numerals and thus, a duplicated description will be omitted.

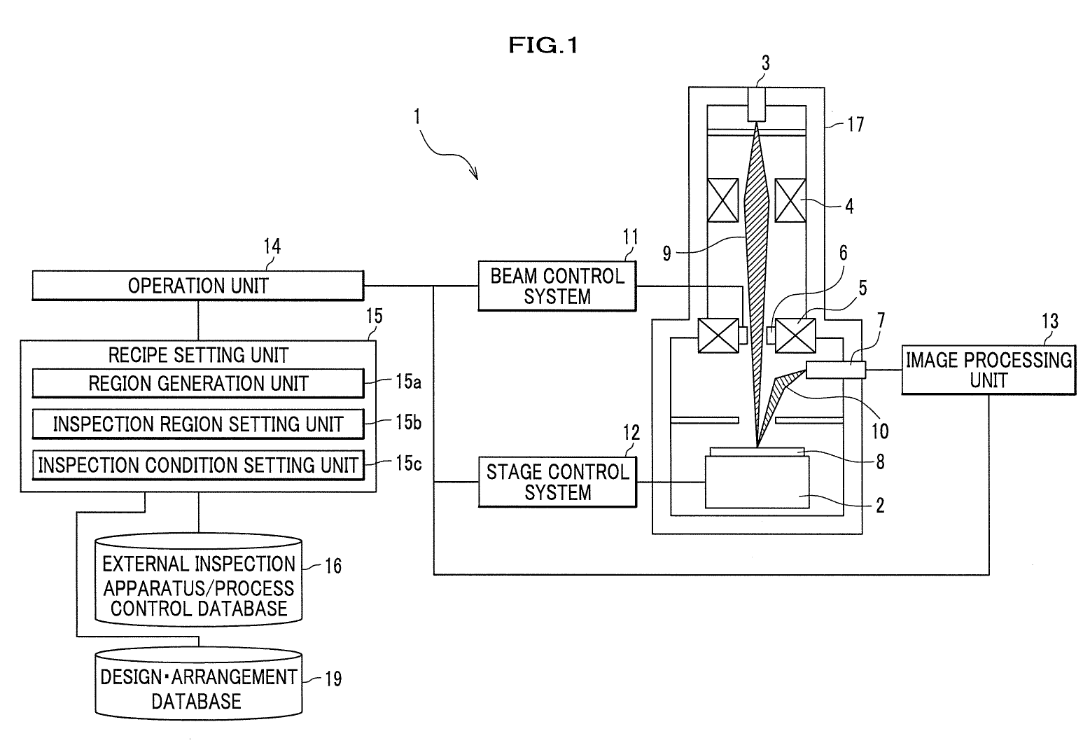

FIG. 1 is a block diagram of an electron beam type wafer (substrate) inspection apparatus 1 according to embodiments of the present invention. The electron beam type wafer (substrate) inspection apparatus 1 comprises a body and a control system of the body. The body includes a column 17 which is an electronic optical system and a stage mechanical system 2. The column 17 includes an electron beam gun 3 for generating an electron beam 9, a condenser lens 4 for focusing the electron beam 9 onto a semiconductor wafer (inspection substrate) 8, an object lens 5, a deflector 6 for scanning the semiconductor wafer 8 with the electron beam 9, and a secondary electron beam detector 7 for detecting a secondary electron 10 generated from the semiconductor wafer 8.

The control system of the electron beam type wafer (substrate) inspection apparatus 1 includes a beam control system 11, a stage control system 12, an image processing unit 13, an operation unit 14, and a recipe setting unit 15.

The beam control system 11 transmits a signal to the deflector 6 which can perform a process of scanning the semiconductor wafer 8 with the electron beam 9 on the basis of the signal. The stage control system 12 transmits a signal to the stage mechanical system 2 which can perform a process of moving the semiconductor wafer 8 on the basis of the signal. Inversely, because the signal generated by the beam control system 11 and the stage control system 12 includes positional information of an irradiation position of the electron beam 9 on the semiconductor wafer 8, an image processing unit 13 can perform a process of obtaining a current irradiation position of the electron beam 9 by receiving these signals.

The secondary electron 10 generated by irradiation of the electron beam 9 from the semiconductor wafer 8 is detected by the secondary electron detector 7 and converted into a signal which is transmitted to the image processing unit 13. The image processing unit 13 links the signal from the secondary electron beam detector 7 with the signals generated by the beam control system 11 and the stage control system 12 (corresponding to information of the current irradiation position) to perform visualization and an image processing process for detecting and visualizing a defect. These processes are controlled by the operation unit 14 which controls these processes on the basis of an inspection recipe. In addition to the operation unit 14, a recipe setting unit 15 is provided to generate an inspection recipe.

When a surface of the semiconductor wafer 8 is irradiated with the electron beam 9, the semiconductor wafer 8 is charged in accordance with a circuit pattern of the semiconductor apparatus including a defect, so that a surface voltage potential distribution according to the circuit pattern including the defect is generated. Using a voltage potential contrast in the surface voltage potential distribution, the defect occurring on the semiconductor wafer 8 can be detected. When an electrical defect such as non-conduction and short-circuit, etc. occurs on a surface or a lower layer of the semiconductor wafer 8, a voltage potential difference is generated between a part bordering on the defect and a part not bordering on the defect. Because the voltage difference is visualized as a difference in contrast on the secondary electron image, the defect can be visualized (recognized) by comparing the adjoining same patterns each other. Because the electron beam type wafer (substrate) inspection apparatus 1 can provide an image with a higher resolution than an optical wafer inspection apparatus, the electron beam type wafer (substrate) inspection apparatus 1 can detect the defects such as an extremely small foreign matter on a fine circuit pattern.

An external inspection apparatus/process control database 16 and a design•arrangement database 19 are provided as external units of the electron beam type wafer (substrate) inspection apparatus 1 and connected to the recipe setting unit 15 to be able to read data stored in the recipe setting unit 15. The recipe setting unit 15 can read out from an external inspection apparatus/process control database 16 and input a product name of the semiconductor apparatus, a process name in a manufacturing process, and an inspection result. The recipe setting unit 15 can read out design data of the semiconductor apparatus and arrangement data of the semiconductor apparatuses on the semiconductor wafer 8 from the design•arrangement database 19.

The recipe setting unit 15 is configured to be attachable to and detachable from the electron beam type wafer (substrate) inspection apparatus 1. In one case, the recipe setting unit 15 is connected to the operation unit 14 when transmitting the inspection recipe generated by the recipe setting unit 15 to the operation unit 14 and when receiving the inspection result at the electron beam type wafer (substrate) inspection apparatus 1. In the other case, the recipe setting unit 15 can advance a generation flow of the inspection recipe without reception from and transmission to the operation unit 14 not only in a state that connection is being kept but also in a case of no-connection. The recipe setting unit 15 includes a region generation unit 15a, an inspection region setting unit 15b, and an inspection condition setting unit 15c. The region generation unit 15a, will be described later in detail, generates a die region, a logic circuit region, a memory region, and a peripheral circuit region on a layout. The inspection region setting unit 15b, also will be described later in detail, sets an inspection region forming the inspection recipe on the basis of the generated die region, a logic circuit region, the memory region, and the peripheral circuit region. The inspection condition setting unit 15c, also will be described later in detail, sets an inspection condition forming the inspection recipe on the basis of the generated die region, the logic circuit region, the memory circuit region, and the peripheral circuit region.

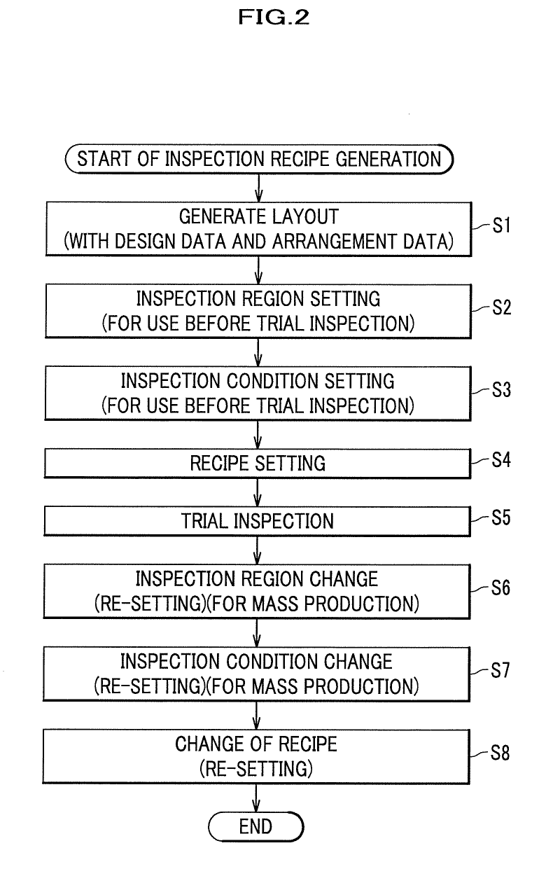

FIG. 2 shows a flowchart for generating an inspection recipe carried out in the electron beam type wafer (substrate) inspection apparatus 1 according to the embodiments of the present invention. In generation of the inspection recipe, first, the region generation unit 15a generates a layout using the design data and the arrangement data in a step S1. Next, in the step S2, the inspection region setting unit 15b sets the inspection region with the layout. In a step S3, the inspection condition setting unit 15c sets the inspection condition with the design data and the layout. In a step S4, the recipe setting unit 15 generates the inspection recipe with the inspection region and the inspection condition and sets the inspection recipe in the operation unit 14. In a step S5, the operation unit 14, etc., perform the trial inspection in accordance with the inspection recipe. In a step S6, the inspection region setting unit 15b changes the inspection region on the basis of the inspection result of the trial inspection and performs resetting. The inspection region set in the step S6 is used for the inspection in the mass-production process of the semiconductor apparatus. In a step S7, the inspection condition setting unit 15c changes and resets the inspection condition on the basis of the inspection result of the trial inspection. The inspection condition setting unit 15c confirms, through image analysis of the detected defect, a brightness and contrast of the defect and resets the inspection condition such as an inspection pixel size•inspection threshold, etc. Then, the inspection condition set in the step S7 is used in the inspection in a mass production process of the semiconductor apparatus. In a step S8, the recipe setting unit 15 changes the inspection recipe using the reset inspection region and inspection condition and sets the changed inspection recipe in the operation unit 14. As described above, the inspection recipe generation flow completes. Hereinbelow will be described each step in detail.

First, in the step S1, the region generation unit 15a generates the layout using the design data and the arrangement data. To perform this step S1, first, the region generation unit 15a reads out the product name and the process name of the semiconductor apparatus to be inspected from the external inspection apparatus/process control database 16 and display a list. The region generation unit 15a provides a display for promoting a selection by an operator as to the product name and the process name of the semiconductor apparatus which is a target of generating the inspection recipe. The operator, as watching the list, selects a product name and a process name of the semiconductor apparatus in response to the prompt. The operator can easily determine the product name and the process name of the semiconductor apparatus which is a target of generating the inspection recipe with assistance of the list display by the region generation unit 15a and the prompt for selection, and input by GUI, etc.

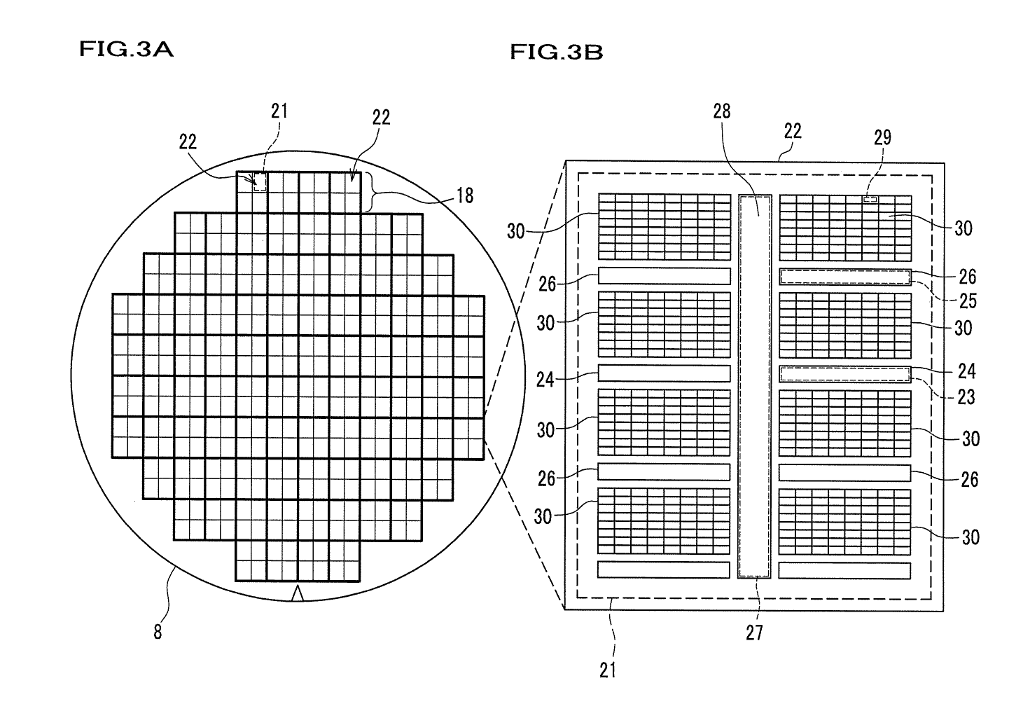

The region generation unit 15a generates and sets, on a layout, the die region 22 indicating a region where a plurality of semiconductor apparatuses 21 are located on the semiconductor wafer 8 as shown in FIG. 3A using the selected product name and process name on the basis of the arrangement data of a plurality of the semiconductor apparatuses formed on the semiconductor wafer 8, i.e., generates and completes a so-called layout. In addition, the region generation unit 15a as shown in FIG. 3B, generates and sets on the layout the logic circuit region 24 indicating a region where there are logic circuit 23, a memory circuit region 30 indicting a region where there is a memory circuit 29, and a peripheral circuit region 26 and 28 indicating a region where the peripheral circuits 25 and 27, i.e., generates and completes the so-called layout.

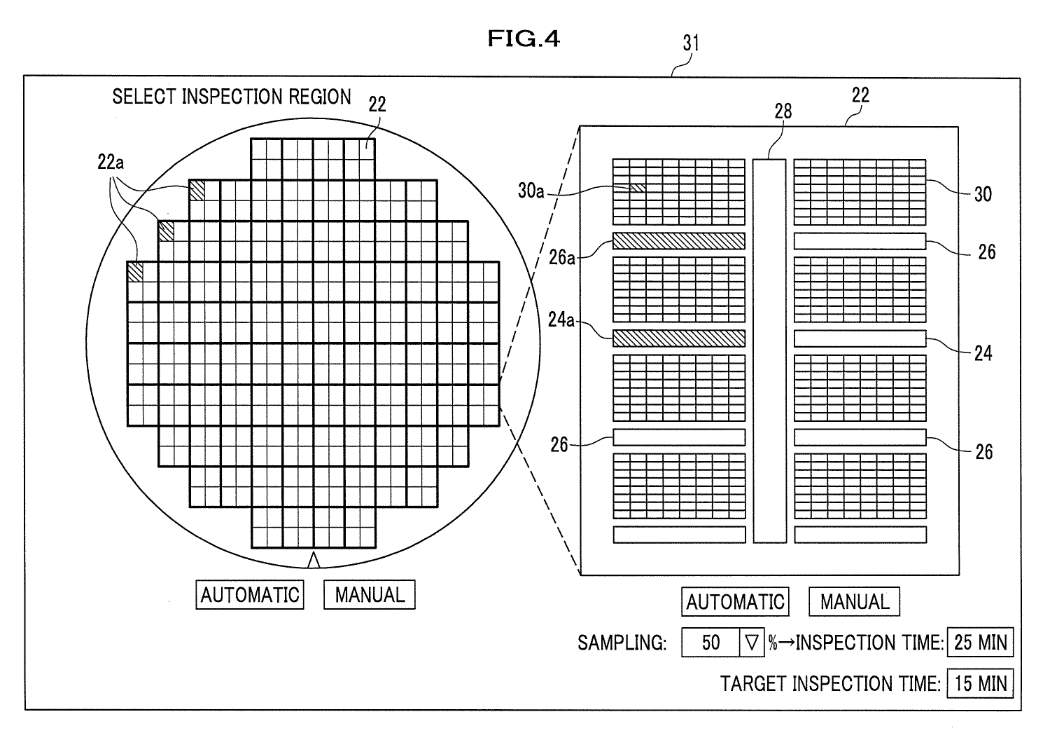

Next, in a step S2, the inspection region setting unit 15b sets the inspection region before the trial inspection with the generated die region 22, logical circuit region 24, memory circuit region 30, and peripheral circuit regions 26 and 28. To conduct the step S2, first, the inspection region setting unit 15b displays the display screen image 31 as shown in FIG. 4. The display screen image 31 displays a layout where the die region 22 is set and a layout where the logic circuit region 24, the memory circuit region 30, and the peripheral circuit regions 26 and 28 are set within the die region 22. On the display screen image 31 “Select Inspection Region” is displayed on the display screen image 31. In response to the displayed prompt, when the operator selects, through GUI, etc., “Manual” at a lower part of the display screen image 31 where a plurality of the die regions 22 are displayed, the die region 22a to be selected as an inspection region can be set on the display screen image 31 through GUI . In addition, the operator selects “Manual” at the lower part of the display screen image 31 indicting an arrangement inside the die region 22 through the GUI, etc., the operator can set the logic circuit region 24a, the memory circuit region 30a, and the peripheral circuit region 26a to be selected as the inspection region through GUI on the display screen image 31. The operator can easily determine the inspection region by the display on the display screen image 31, and the prompt for selection of the inspection region by the inspection region setting unit 15b and by assistance for selection•setting with GUI, etc. Although a detailed description will be made later, when the operator selects “Automatic” instead of “Manual”, the inspection region setting unit 15 can set the inspection region without selection of the inspection region by the operator.

On the display screen image 31, “Sampling” and “Inspection Time”, and “Target Inspection Time” are displayed. Near the display of “Sampling”, a list box is provided to display a ratio of from 0% to 100%, so that, for example, a list can be displayed for selecting a ratio, such as 50%. The operator can input with GUI a desired ratio selected from the alternatives of the ratio displayed in the list into the inspection region setting unit 15b. The sampling ratio indicates a ratio of the number of regions selected from a plurality of the die regions 22, a plurality of the logic circuit regions 24, a plurality of memory circuit regions 30, a plurality of peripheral circuit regions 26 and 28. When the ratio is input, the region such as the die region 22 is set (selected) every predetermined number of regions so that the input ratio is satisfied. When the inspection region is set, an area of the inspection region can be calculated, so that the inspection time can be calculated on the basis of the area. The calculated inspection time is displayed in a text box provided near an indication of “Inspection Time”. For the example shown in FIG. 4 “25 minutes” is displayed as the inspection time. As the operator watches the inspection time, when the inspection time deviates from a target inspection time as which the operator considers an appropriated inspection time, the operator can input the sampling ratio changed so as to match the target inspection time with the list box.

Also near an indication of “Target Inspection Time”, a text box is provided. The operator can input, with the text box, the target inspection time which the operator aims. On the other hand, the inspection region setting unit 15b calculates the inspection time when the sampling ratio is 100% on the basis of a total area of a plurality of the die area 22, etc. The sampling ratio is calculated on the basis of the ratio of the target inspection time to the inspection time. On the basis of the calculated sampling ratio, it is possible to select, for example, the die regions 22a, the logic circuit region 24a, the memory circuit region 30a, and the peripheral circuit regions 26a.

In addition, to assist the operator's selection for the inspection region, the following assistance is effective.

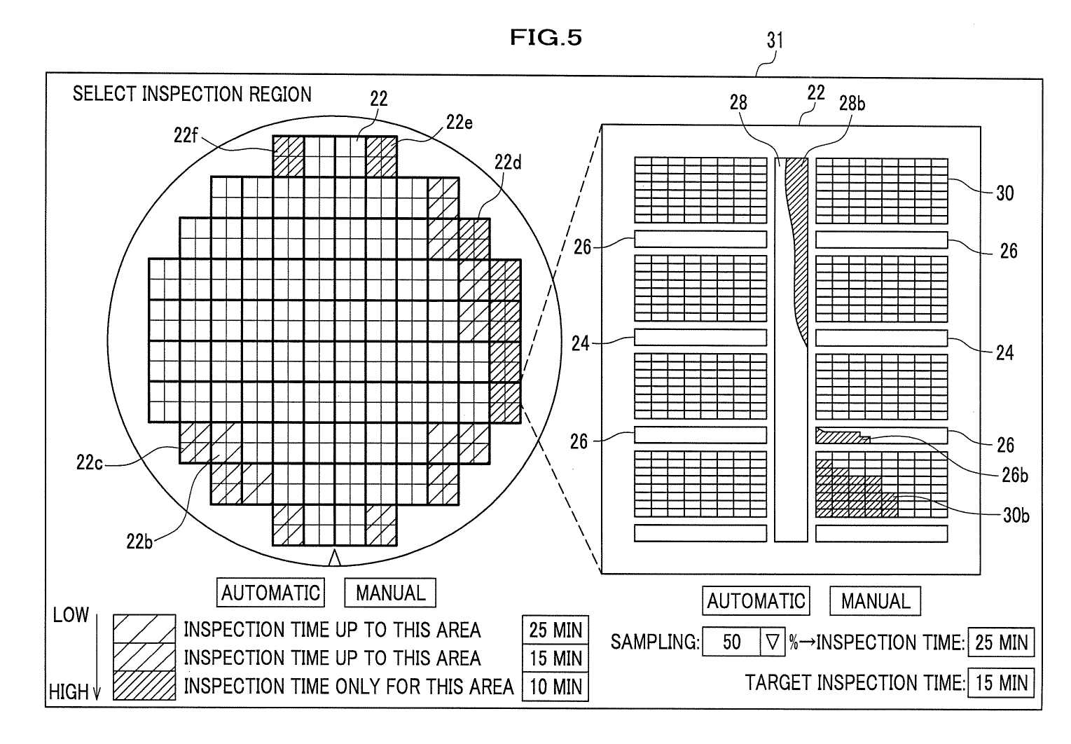

The inspection region setting unit 15b reads out the inspection result of previously manufactured semiconductor apparatuses related to the semiconductor apparatus having the same product name and the same process name as the semiconductor apparatus has from the external inspection apparatus/process control database 16 and inputs the inspection result. The inspection region setting unit 15b obtains a defect occurrence frequency of defects which previously occurred in the die region 22, the logic circuit region 24, the memory circuit region 30, and the peripheral circuit regions 26, 28 on the basis of the past inspection result through a statistics process. The inspection setting unit 15b extracts the die regions, the logic circuit regions, the memory circuit regions, and the peripheral circuit regions, having defect occurrence frequencies higher than a predetermined frequency threshold. As shown in FIG. 5, the inspection region setting unit 15b displays such a layout that the extracted die regions 22b, 22c, and 22d can be discriminated from other die regions 22. The die region 22b has the defect occurrence frequency higher than the die region 22c, and the die region 22d has the defect occurrence frequency higher than the die region 22c. The die region 22b and the die region 22c are divided with a border value having the defect occurrence frequency higher than the frequency threshold. Similarly, the die region 22c and the die region 22d are divided by a border value having a defect occurrence frequency higher than a frequency threshold. The inspection region setting unit 15b displays such a layout that the extracted memory circuit region 30b, the peripheral circuit region 26b and 28b can be discriminated from other memory circuit region 30, and the peripheral circuit regions 26, 28. The operator, as watches these display screen images, can select as an inspection region, for example, the die regions 22b, 22c, and 22d, and the memory circuit region 30b, and the peripheral circuit regions 26b, 28b which are discriminately displayed. Such selection can provide an efficient assistance for the operator to easily select without depending on experience of the operator.

On the display screen image 31, “an inspection time for only (regions hatched similarly to the die region 22d)”, an inspection time for only (regions hatched similarly to the die region 22d to regions hatched similarly to the die region 22c)“, and an inspection time for (regions hatched similarly to the die region to regions hatched similarly to the die region 22b)” are displayed. The inspection region setting unit 15b can calculate areas of a plurality of die regions 22b, and a plurality of die regions 22c, and a plurality of the die regions 22d. The inspection time for only regions hatched similarly to the die region 22d) can be calculated on the basis of a plurality of the die regions 22d. The inspection time for from the regions hatched similarly to the die region 22d to the region hatched similarly to the die regions 22c can be calculated on the basis of a sum area of the die region 22d and the die region 22c. The inspection time for the regions hatched similarly to the die region 22d to the regions hatched similarly to the die regions 22b can be calculated on the basis of a sum area of the die region 22d, the die region 22c, and the die region 22b. The operator can easily grasp whether the die regions to be inspection regions satisfying the target inspection time which the operator aims are only the die region 22d, the die regions 22d and 22c, or the die regions 22d, 22c, and 22b, so that the operator can select the die region satisfying the condition.

In the peripheral circuit regions 26b and 28b, it is possible to select a whole of the peripheral circuit regions 26 and 28 including the peripheral circuit regions 26b and 28b as an inspection region and also possible to select a part of the peripheral circuit regions 26b and 28b. For this, for example, one of the peripheral circuit regions 26 and 28 is divided into a plurality of small regions.

The following setting method is efficient to set the inspection region without selection of the inspection region by the operator, i.e., to set the inspection area in the so-called automatic mode.

When the operator does the selection of “automatic” at low part of the display screen image 31 with, for example, GUI, the inspection region setting unit 15b displays an indication to prompt the user to set the target inspection time. In response to the prompt, the operator inputs a desired target inspection time with GUI in a text box of the target inspection time.

Next, the inspection region setting unit 15b reads out the inspection result of the previously manufactured semiconductor apparatus related to the semiconductor apparatus because of having the same product name and the same process name as the semiconductor apparatus from the external inspection apparatus/process control database 16. A defect occurrence frequency of defects which previously occurred in the die region 22, the logic circuit region 24, the memory circuit region 30, and the peripheral circuit regions 26 and 28 are obtained on the basis of the past inspection result.

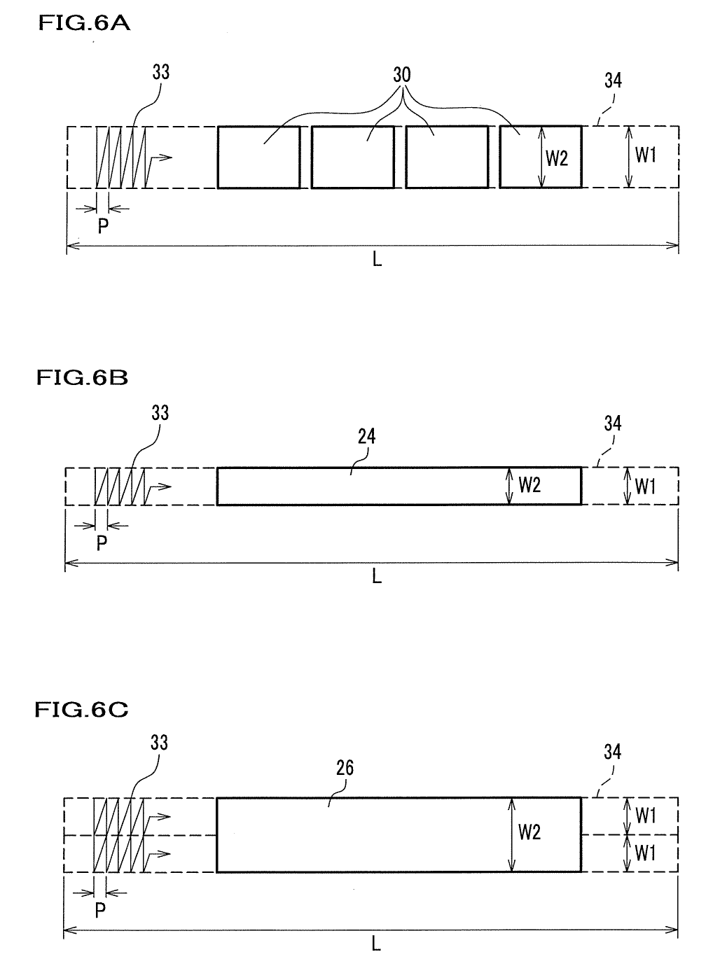

Next, as shown in FIGS. 6A, 6B, and 6C, the inspection region setting unit 15b sets a scanning region 34. The scanning region 34 is an electron beam irradiation region which is scanned with the electron beam 9 (see FIG. 1) so as cover the inspection region. The die regions 22, the logic circuit regions 24, the memory regions 30, and the peripheral circuit regions 26 having defect occurrence frequencies higher than a predetermined frequency threshold are regarded as the inspection regions, and the scanning region 34 is set to cover the inspection region.

The inspection region setting unit 15b calculates the inspection time on the basis of the area of the scanning region 34. The inspection region setting unit 15b extracts the die regions 22, the logic circuit regions 24, the memory regions 30, and the peripheral circuit regions 26, 28 having defect occurrence frequencies higher than a maximum frequency threshold within a range where the inspection time does not exceed the target inspection time. This allows the die regions 22, the logic circuit regions 24, the memory regions 30, and the peripheral circuit regions 26, 28 to be extracted so that the inspection time can match the target inspection time approximately. The operator can easily grasp an area of the inspection region by that the extracted die regions 22, logic circuit regions 24, memory regions 30, and peripheral circuit regions 26, 28 are displayed as a distribution chart as shown in FIG. 5.

In addition, as shown in FIGS. 6A and 6B, a scanning path 33 of the electron beam 9 is set with respect to the scanning region 34 as follows:

A turnaround width (electron beam irradiation width) W1 is set to be equal to a scanning width W2 of the scanning region 34. As shown in FIG. 6C, a sum of the turnaround widths W1 (W1+W1) of the scanning paths 33 of the electron beam 9 extending in parallel is set to be equal to the scanning width W2 of the scanning region 34.

A scanning interval P in which the scanning region is scanned with the electron beam 9 is set as an inspection condition, and is preferably set on the basis of a minimum design dimension in design data of the semiconductor apparatus 21 (see FIG. 3), the logic circuit 23, the memory circuit 29, and the peripheral circuits 25 and 27. The scanning interval P determines an inspection pixel size of the inspection image which determines a size of the defect which can be detected. On the basis of an area of the scanning region 34 and the inspection pixel size (scanning interval P), an accurate inspection time can be calculated.

In addition, as shown in FIG. 6A, when a plurality of memory circuit regions 30 are arranged in a row, one scanning region 34 is set to cover a plurality of the memory circuit regions 30. Accordingly, the scanning region 34 is also set to gaps between the memory circuit regions which are not the memory circuit region 30. On the other hand, when the die region 22e and the die region 22f shown in FIG. 5 are selected as the inspection region, and die regions between the die region 22e and the die region 22f are not selected as the inspection region, so that the die region 22e and the die region 22f are separated, the scanning regions 34 are set for the die region 22e and the die region 22f independently. More specifically, the scanning region 34 covering the die region 22e and the scanning region 34 covering the die region 22f are located apart from each other. Accordingly, scanning of the electron beam 9 is performed by a step-and-repeat method, so that a region between the scanning region 34 covering the die region 22e and the scanning region 34 covering the die region 22f is not scanned with the electron beam 9.

In the description above, the defect occurrence frequency is calculated on the basis of the past inspection result, and assistance in selecting the inspection region and setting of the inspection region were made by extracting the die region 22, the logic circuit region 24, the memory circuit region 30, and the peripheral circuit regions 26, 28 to be set as the inspection region on the basis of the defect occurrence frequency. However, the embodiment is not limited to this. For example, two methods can be used as follows:

In the first method, first, an area ratio of an area occupied by at least one of plugs, wirings, and holes to each of the areas of the die region 22, the logic circuit region 24, the memory circuit region 30, and the peripheral circuit regions 26, 28, is calculated on the basis of the design data of the semiconductor apparatus. Next, these area ratios are displayed so as to be related with the corresponding die region 22, logic circuit region 24, memory circuit region 30, and peripheral circuit regions 26, 28 which have been already displayed on the display screen image 31, i.e., displayed in a superimposition manner. Finally, because an area having a greater area ratio such as the logic circuit regions 24 and the memory circuit regions 30 generally have a tendency that a defect easily occurs, with reference to these area ratios, the operator selects the area as the inspection region, if the operator know this, the operator can make determination in selection for the inspection region by only watching the display of the area ratios. In other words, the display (means) of the area ratio serves as a means to prompt the operator to select the inspection region in the manual operation together with the display of “Select Inspection Region”. In addition, the inspection region in the automatic operation can be set when an area ratio threshold is provided, the die regions 22, the logic circuit regions 24, the memory circuit regions 30, and the peripheral circuit regions 26, 28 having area ratios not smaller than the area ratio threshold are extracted and are regarded as the inspection region as they are.

Next, will be described a second method. In the second method, first, it is determined whether a specific circuit pattern is present in the die region 22, the logic circuit regions 24, the memory circuit regions 30, and the peripheral circuit regions 26, 28 on the basis of the design data of the semiconductor apparatus 21. The specific circuit pattern is, for example, a circuit pattern where plugs, wirings, holes are arranged at a high density or a low density. Next, the die region 22, the logic circuit regions 24, the memory circuit regions 30, and the peripheral circuit regions 26, 28 on which the specific circuit pattern are present are discriminately displayed on the display screen image 31 from the die region 22, the logic circuit regions 24, the memory circuit regions 30, and the peripheral circuit regions 26, 28 on which the specific circuit pattern are not present. Finally, the operator determines to select the inspection region with reference to the discriminative display as to whether the specific circuit pattern is present. In other words, the discriminative display (means) as to whether the specific circuit pattern is present serves as a means for prompting the operator to select the inspection region in the manual operation mode together with the display of “Select Inspection Region”. In addition, if the die region 22, the logic circuit regions 24, the memory circuit regions 30, and the peripheral circuit regions 26, 28 where the specific circuit pattern is present are extracted and are determined as the inspection region as they are, this provides setting of the inspection region in the automatic operation.

The description of the inspection region setting in the step S2 in FIG. 2 has been completed. Next will be described the inspection condition setting in the step S3.

As the inspection condition setting, the irradiation condition of the electron beam 9 is mainly set. More specifically, the inspection condition setting unit 15c displays a list of setting items such as an accelerated voltage of the electron beam 9, a current, the inspection pixel size (corresponding to the scanning interval P in FIGS. 6A to 6C) and a text box allowing the operator to input for every setting item. The operator can input desired values in setting items thoroughly with assist by these displays, and the inspection condition setting unit 15c can set the inspection condition on the basis of the input. In addition, also the inspection pixel size (scanning interval P) can be set on the basis of the minimum design dimensions of the die region 22, the logic circuit regions 24, the memory circuit regions 30, and the peripheral circuit regions 26, 28 obtained from the design data.

Next, in a recipe setting in a step S4, the inspection recipe is generated (set), which allows the set (stored) inspection condition and the inspection region to be read, and set (stored) in the operation unit 14.

Next, in the trial inspection in a step S5, the operation unit 14 reads out the inspection recipe and further reads out the inspection condition and the inspection region on the basis of the inspection recipe. The operation unit 14 conducts the inspection for from one to several sheets of semiconductor wafers (inspection substrate) 8 (see FIG. 3) in accordance with the inspection condition and the inspection region. In addition, because the inspection region corresponds to only a part of a total of the die region 22, the logic circuit regions 24, the memory circuit regions 30, and the peripheral circuit regions 26, 28, the inspection region is made become small areas, so that the inspection time can be shortened.

In the inspection, the operation unit 14 detects a candidate of defects and obtains the secondary electron image for each detected candidate of defect. The operation unit 14 performs an image analysis of the secondary electron image and measures and stores a brightness and contrast of the candidate of the defects. Next, the operation unit 14 calculates a detection threshold on the basis of the brightness and the contrast for each candidate of the defect. The operation unit 14 stores, as an inspection result, a defect ID of the candidate of defect having a detection threshold not smaller than a predetermined obtaining lower limit threshold, defect coordinates, the detection threshold, a size, the brightness, and the contrast, which are related with each other. Finally, the operation unit 14 displays the secondary electron image on the display screen for each candidate of defect to prompt the operator to determine whether the candidate of the displayed detect is a defect or not and stores the determination result so as to be related with the defect ID. By the assist of the defect determination, the operator can easily select the candidate of defects as the defects.

Next, in change in the inspection region in a step S6 the inspection region is changed with the inspection result of the trial inspection, and an inspection region of the inspection recipe used in the inspection process in a manufacturing process of the semiconductor apparatus 21 is generated.

Then, in the step S6, first, the inspection region setting unit 15b reads out the inspection result of the trial inspection of the semiconductor wafer 8. Next, the inspection region setting unit 15b obtains the number of occurrences of the defects detected in the respect regions of the die region 22, the logic circuit regions 24, the memory circuit regions 30, and the peripheral circuit regions 26, 28 on the basis of the defect ID, the defect coordinates, and the defect determination result, of the inspection result. Next, the inspection region setting unit 15b extracts the die region 22, the logic circuit regions 24, the memory circuit regions 30, and the peripheral circuit regions 26, 28 having the number of occurrences higher than a predetermined the-number-of-defect-occurrence threshold.

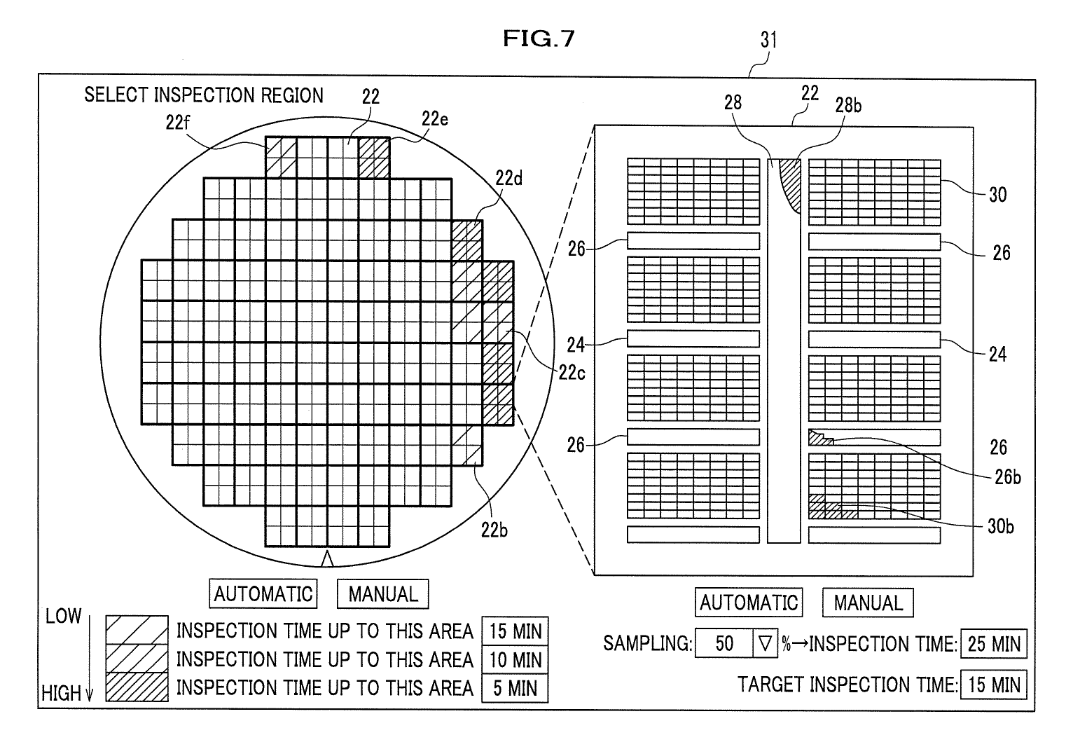

As shown in FIG. 7, the inspection region setting unit 15b displays the extracted die regions 22b, 22c, and 22d in such a layout that the extracted die regions 22b, 22c, and 22d can be discriminated from other die regions 22. The number of occurrences on the die regions 22b is greater than that on the die region 22c which is greater than the number of occurrences on the die region 22d. The die region 22b and the die region 22c are divided by a border value of the number of occurrences higher than the number-of threshold. Similarly, the die region 22c and the die region 22d are divided by a border value of the number of occurrences higher than the-number-of threshold. In addition, the inspection region setting unit 15b displays the extracted memory regions 30b and the peripheral circuit region 26b, 28b in such a layout that the extracted memory regions 30b and the peripheral circuit region 26b, 28b can be discriminated from other memory regions 30 and peripheral circuit regions 26, 28. The operator, as watching these display screen images, can select, for example, the die regions 22b, 22c, and 22d, and the memory circuit region 30b, and the peripheral circuit regions 26b, 28b which are discriminately displayed as an inspection region. Such selection can provide an efficient assistance for the operator to easily select without depending on experience of the operator.

On the display screen image 31, “an inspection time for only (regions hatched similarly to the die region 22d)”, “an inspection time for only (regions hatched similarly to the die region 22d to regions hatched similarly to the die region 22c)”, and “an inspection time for (regions hatched similarly to the die region to regions hatched similarly to the die region 22b)” are displayed. The inspection region setting unit 15b can calculate areas of a plurality of die regions 22b, and a plurality of die regions 22c, and a plurality of the die regions 22d. The inspection time for only regions hatched similarly to the die region 22d) can be calculated on the basis of a plurality of the die regions 22d. The inspection time for from the regions hatched similarly to the die region 22d to the region hatched similarly to the die regions 22c can be calculated on the basis of a sum area of the die region 22d and the die region 22c. The inspection time for the regions hatched similarly to the die region 22d to the regions hatched similarly to the die regions 22b can be calculated on the basis of a sum area of the die region 22d, the die region 22c, and the die region 22b. The operator can easily grasp whether the die regions to be inspection regions satisfying the target inspection time which the operator aims are only the die region 22d, the die regions 22d and 22c, or the die regions 22d, 22c, and 22b, so that the operator can select the die region 22 satisfying the condition.

In the peripheral circuit regions 26b and 28b, it is possible to select a whole of the peripheral circuit regions 26 and 28 including the peripheral circuit regions 26b and 28b as an inspection region and also possible to select a part of the peripheral circuit regions 26b and 28b. For this, for example, one of the peripheral circuit regions 26 and 28 is divided into a plurality of small regions.

It is also possible to set the inspection region without selection of the inspection region by the operator, i.e., to set the inspection area in the automatic mode. When the operator performs the selection of “Automatic” at low part of the display screen image 31 with GUI, etc., the inspection region setting unit 15b displays an indication to prompt the user to set the target inspection time. In response to the prompt, the operator inputs a desired target inspection time with GUI in a text box of the target inspection time.

Next, the inspection region setting unit 15b obtains a defect occurrence frequency of defects which previously occurred in the die region 22, the logic circuit region 24, the memory circuit region 30, and the peripheral circuit regions 26 and 28 on the basis of the inspection result of the trial inspection.

Next, the inspection region setting unit 15b regards, as the inspection regions, the die regions 22, the logic circuit regions 24, the memory regions 30, and the peripheral circuit regions 26 having the number of defect occurrences higher than a predetermined the-number-of-defect-occurrence threshold and set the inspection region so as to cover the scanning region 34 (see FIGS. 6A to 6C).

The inspection region setting unit 15b calculates the inspection time on the basis of the area of the scanning region 34. The inspection region setting unit 15b extracts the die regions 22, the logic circuit regions 24, the memory regions 30, and the peripheral circuit regions 26, 28 having the number of defect occurrences higher than the maximum the-number-of-defect-occurrence threshold in the range where the inspection time does not exceed the target inspection time. This allows the die regions 22, the logic circuit regions 24, the memory regions 30, and the peripheral circuit regions 26, 28 to be extracted such that the inspection time approximately matches the target inspection time. The operator can easily grasp an area of the inspection region by that the die regions 22, the logic circuit regions 24, the memory regions 30, and the peripheral circuit regions 26, 28, which are extracted, are displayed as a distribution chart as shown in FIG. 7.

Next, in the change of inspection condition in the step S7, the inspection condition is changed using the inspection result of the trial inspection, and an inspection condition for the inspection recipe used in the inspection process in the mass-production process of the semiconductor apparatus 21 is prepared. Then, in the step S7, first, the inspection condition setting unit 15c sets again an acceleration voltage and current of the electron beam 9 using a database which allows an appropriate acceleration voltage and current to be extracted using the brightness and contrast on the basis of the inspection result of the trial inspection, particularly, the brightness and contrast. In addition, the inspection pixel size is set again on the basis of a minimum value in a size of the candidate defects which have been determined as defects.

In addition, the obtaining lower limit threshold is set again on the basis of a minimum value in a detection threshold of the candidate defects which have been determined as defects. The obtaining lower limit may be set again as mentioned below. First, the defect occurrence frequency is obtained on the basis of the past inspection results similarly to the step S3. Next, the die regions 22, the logic circuit regions 24, the memory regions 30, and the peripheral circuit regions 26, 28 having defect occurrence frequencies higher than a predetermined frequency threshold are extracted.

Next, the number of defect occurrences detected in the die regions 22, the logic circuit regions 24, the memory regions 30, and the peripheral circuit regions 26, 28 is obtained on the basis of the inspection result of the trial inspection, particularly, coordinates of the defects. Then, the die regions 22, the logic circuit regions 24, the memory regions 30, and the peripheral circuit regions 26 having defect occurrence frequencies higher than a predetermined the-number-of-defect-occurrence threshold, are extracted.

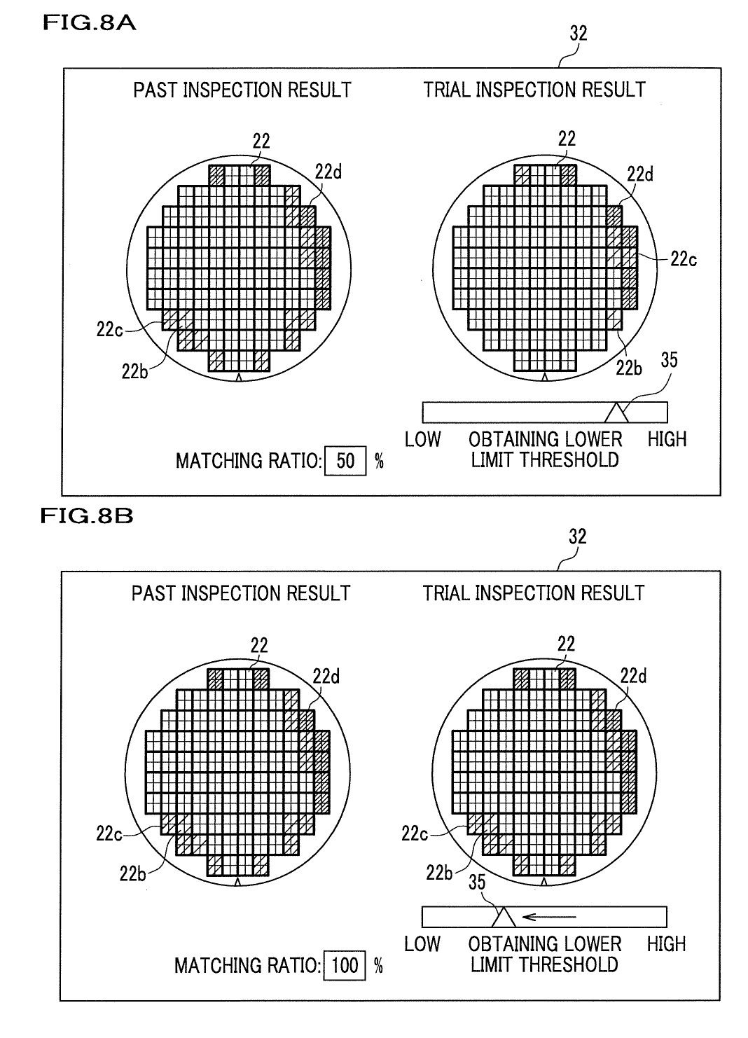

As shown in FIG. 8A, a layout discriminately displaying the die regions 22b, 22c, and 22d having defect occurrence frequencies higher than the predetermined frequency threshold based on the past inspection result and a layout discriminately displaying the die regions 22b, 22c, and 22d having the number of occurrences higher than a predetermined the-number-of-defect-occurrence threshold based on the inspection result of the trial inspection, are discriminatively displayed at the same time on the display screen image 32.

Next, a matching ratio is calculated between the die regions 22b, 22c, and 22d extracted because the number of defect occurrences is higher than the predetermined the-number-of-defect-occurrence threshold and the die regions 22b, 22c, and 22d extracted because the defect occurrence frequency is higher than the predetermined defect occurrence frequency threshold. The matching ratio can be calculated as a ratio of the number of the die regions extracted on both sides to the number of the die regions extracted on at least one of sides. The maximum matching ratio is 100% and it is considered that the closer to 100% the matching ratio is, the more a sensitivity of the trial inspection accords with the past inspections. Accordingly, when the matching ratio is, as shown in FIG. 8A, 50% which is low, and the number of the die regions 22b, 22c, and 22d extracted in the inspection result of the trial inspection is smaller than that of the die regions 22b, 22c, and 22d extracted in the past inspection result, as shown in FIG. 8B, the obtaining lower limit threshold is lowered with the threshold change tool 35 to set the obtaining lower limit threshold when the matching ratio becomes a maximum.

Finally, in the recipe change in the step S8, the inspection recipe is changed to an inspection recipe from which the inspection condition and the inspection region set again can be read, and the inspection recipe is set (store) in the operation unit 14. Then, the recipe generation is completed.

The electron beam type wafer inspection apparatus 1 according to the embodiments capable to generate the inspection recipe as mentioned above regards the die regions 22, the logic circuit regions 24, the memory circuit regions 30, the peripheral circuit regions 26, 28 as the inspection region, while the other regions are excluded from the inspection region, so that an area of the inspection region can be made smaller, and thus the inspection time can be shortened. In addition, because various assistance means are prepared when the operator selects the inspection region from a plurality of the die regions 22, a plurality of logical circuit regions 24, a plurality of the memory circuit regions 30, and a plurality of peripheral circuit regions 26, 28, the operator can make selection easily and in a short time without depending on his own experience and judgment.

### DESCRIPTION OF REFERENCE NUMERALS

1 electron beam type wafer inspection apparatus

2 stage mechanical system

3 electron beam gun

4 condenser lens

5 object lens

6 deflector

7 secondary electron beam detector

8 semiconductor wafer (inspection substrate)

9 electron beam

10 secondary electron (signal)

11 beam control system

12 stage control system

13 image processing unit

14 operation unit

15 recipe setting unit

15a region generation unit

15b inspection region setting unit

15c inspection condition setting unit

16 external inspection apparatus/process control database

17 column

19 design•arrangement database

21 semiconductor apparatus

22 die region

23 logic circuit

24 logic circuit region

25 peripheral circuit

26 peripheral circuit region

27 peripheral circuit

28 peripheral circuit region

29 memory circuit

30 memory circuit region

31, 32 display screen image

33 scanning path

34 scanning region (electron beam irradiation region)

35 threshold change tool

1. An electron beam type substrate inspection apparatus for inspecting a defect on an inspection substrate, including means for scanning an inspection substrate within an inspection region on the inspection substrate with an electron beam; means for detecting a signal generated from the inspection substrate; and means for imaging with a scanning position on the inspection substrate being related with the signal, comprising:
means for generating, on a layout, at least one of: die regions each indicating a die region where a plurality of semiconductor apparatuses are located on the inspection substrate; a logic region indicating a region where a logic circuit is located in the semiconductor apparatus; a memory circuit region indicating a region where a memory circuit is located in the semiconductor apparatus; and a peripheral circuit region indicating a region where a peripheral circuit is located in the semiconductor apparatus as a region, on the basis of arrangement data of a plurality of semiconductor apparatuses formed on a surface of the inspection substrate and design data of the semiconductor apparatuses; and
means for setting the inspection region using the generated region.

2. The electron beam type substrate inspection apparatus according to claim 1, wherein the means for setting the inspection region displays the region and prompts an operator to select the region as the inspection region.

3. The electron beam type substrate inspection apparatus according to claim 1, further comprising:
means for setting a scanning region scanned with an electron beam to cover the inspection region; and
means for setting a scanning turn-around width so as to equalize the scanning turn-around width and a sum of the scanning turn-around width to a scanning width of the scanning region.

4. The electron beam type substrate inspection apparatus according to claim 1, wherein the means for generating the region displays a list of respective product names of a plurality of kinds of the semiconductor apparatuses and a list of serial production process names of the semiconductor apparatuses on the basis of a process control database used for controlling manufacturing the semiconductor apparatuses, prompts an operator to make selection from the product names and the process names of the semiconductor apparatuses to be inspected, and reads out the arrangement data and the design data on the basis of the selected production name and production process names.

5. The electron beam type substrate inspection apparatus according to claim 1, further comprising means for setting an scanning interval for scanning within the inspection region with the electron beam on the basis of a minimum design dimension in the design data of the semiconductor apparatus, the logical circuit, the memory circuit, and the peripheral circuit which are located in the inspection region.

6. The electron beam type substrate inspection apparatus according to claim 1, wherein the means for setting the inspection region calculates an area ratio of an area occupied by at least one of a plug, a wiring, and a hole to an area of the die region, the logic circuit region, the memory circuit region, the peripheral circuit region generated on the basis of the design data, displays the area ratio with relation with the die region, the logic circuit region, the memory circuit region, the peripheral circuit region, and prompts the operator to make selection from the generated die region, the logical circuit region, the memory circuit region, and the peripheral circuit region as the inspection region on the basis of the area ratio.

7. The electron beam type substrate inspection apparatus according to claim 1, wherein the means for setting the inspection region determines whether a specific circuit pattern is present or not in the generated die region, the generated logical circuit region, the generated memory circuit region, and the generated peripheral region, displays the die region, the logical circuit region, the memory circuit region, and the peripheral region where the specific circuit pattern is present discriminately from the die region, the logical circuit region, the memory circuit region, and the peripheral region where the specific circuit pattern is not present, and prompts the operator to select the die region, the logical circuit region, the memory circuit region, and the peripheral region where the specific circuit pattern is present as the inspection region.

8. The electron beam type substrate inspection apparatus according to claim 1, wherein the means for setting the inspection region prompts the operator to set a target inspection time, obtains a defect occurrence frequency of a defect which previously occurred in the die region, the local circuit region, the memory circuit region, and the peripheral circuit region on the basis of the inspection result of the semiconductor apparatus previously manufactured to which the same product name as the semiconductor apparatus has is related, makes setting to cover the die region, the local circuit region, the memory circuit region, and the peripheral circuit region having the defect occurrence frequency higher than the frequency threshold within the scanning region scanned with the electron beam to cover the inspection region, calculates inspection time on the basis of the scanning region, and extracts the die region, the logical circuit region, the memory circuit region, and the peripheral circuit region having the defect occurrence frequency higher than the frequency threshold which becomes a maximum within a range where the inspection time does not exceed the target inspection time.

9. The electron beam type substrate inspection apparatus according to claim 1, wherein the means for setting the inspection region prompts the operator to set a target inspection time, obtains the number of occurrences of defects detected in the die region, the local circuit region, the memory circuit region, and the peripheral circuit region on the basis of the inspection result of the trail inspection of the inspection substrate, makes setting to cover the die region, the local circuit region, the memory circuit region, and the peripheral circuit region having the number of occurrences of the defect higher than a predetermined the-number-of-occurrence threshold within the scanning region scanned with the electron beam to cover the inspection region, calculates the inspection time on the basis of the scanning region, and extracts the die region, the logical circuit region, the memory circuit region, and the peripheral circuit regions having the number of occurrence of defects higher than the-number-of-occurrence threshold which becomes a maximum within a range where the inspection time does not exceed the target inspection time.

10. The electron beam type substrate inspection apparatus according to claim 1, wherein the means for setting the inspection region obtains a defect occurrence frequency of defects which have previously occurred in the die region, the local circuit region, the memory circuit region, and the peripheral circuit region on the basis of the inspection result of the semiconductor apparatus which is previously manufactured and to which the same product name as the semiconductor apparatus has is related, and extracts the die region, the logical circuit region, the memory circuit region, and the peripheral circuit region having the defect occurrence frequency of the defects higher than a predetermined frequency threshold.

11. The electron beam type substrate inspection apparatus according to claim 1, wherein the means for setting the inspection region obtains the number of occurrences of defects detected in the die region, the local circuit region, the memory circuit region, and the peripheral circuit region on the basis of the inspection result of the trail inspection of the inspection substrate, and extracts the die region, the logical circuit region, the memory circuit region, and the peripheral circuit region having the number of occurrence of defects higher than a predetermined the-number-of-occurrence threshold.

12. The electron beam type substrate inspection apparatus according to claim 1, further comprising:
means for measuring a brightness and a contrast of a visualized defect in a trial inspection of the inspection substrate;
means for calculating inspection threshold inherent to the defect on the basis of the brightness or the contrast;
means for storing coordinates of the defect corresponding to the detection threshold not smaller than a predetermined obtaining lower limit threshold, wherein
the means for setting the inspection region:
obtains a defect occurrence frequency of the defect which have previously occurred in the die region, the logical circuit region, the memory circuit region, the peripheral circuit region on the basis of the inspection result of the semiconductor apparatus which is previously manufactured and to which the same product name as the semiconductor apparatus has is related;
extracts the die region, the logical circuit region, the memory circuit region, and the peripheral circuit region having the defect occurrence frequency higher than a predetermined frequency threshold;
obtains the number of occurrences of defects detected in the die region, the local circuit region, the memory circuit region, and the peripheral circuit region on the basis of the coordinates of the defect;
extracts the die region, the local circuit region, the memory circuit region, and the peripheral circuit region having the number of occurrences of the defect higher than a predetermined the-number-of-occurrence threshold;
calculates a matching ratio of detects between the die region, the logic circuit region, the memory circuit region, and the peripheral circuit region extracted because the number of occurrences is higher than the predetermined the-number-of-occurrence threshold and the die regions extracted because the defect occurrence frequency is higher than the predetermined frequency threshold, if the obtaining lower limit threshold is temporally increased and decreased; and
sets the obtaining lower limit threshold such that the matching ratio becomes a maximum.

13. The electron beam type substrate inspection apparatus according to claim 1, further comprising: means for setting a plurality of scanning regions to be scanned with the electron beam to cover the inspection region, wherein a plurality of the scanning regions are located separately from each other to allow the electron beam to be scanned with the electron beam by a step-and-repeat method.
